(19) United States
(12) Patent Application Publication
(10) Pub. No.: US 2020/0021867 A1
(43) Pub. Date: Jan. 16, 2020

(54) BROADCAST SIGNAL TRANSMITTING AND RECEIVING METHOD AND DEVICE

(71) Applicant: LG ELECTRONICS INC., Seoul (KR)

(72) Inventors: Jonghwan PARK, Seoul (KR); Woosuk KWON, Seoul (KR); Joonhee YOON, Seoul (KR)

(21) Appl. No.: 16/495,365

(22) PCT Filed: Nov. 17, 2017
(86) PCT No.: PCT/KR2017/013069

§ 371 Date: Sep. 18, 2019

Related U.S. Application Data
(60) Provisional application No. 62/475,214, filed on Mar. 22, 2017.
(60) Provisional application No. 62/478,043, filed on Mar. 29, 2017.

(51) Int. Cl. H04N 21/2343; H04N 21/236; H04N 21/2362

(52) U.S. Cl. CPC H04N 21/23439; H04N 21/2362; H04N 21/23605

(57) ABSTRACT

The present invention relates to a device and a method for transmitting and receiving a multicast. The multicast transmitting device, according to one embodiment of the present invention, comprises: a receiving unit for receiving media data; a packetizing unit for packetizing the received media data into media data packets by using a transmission protocol; and a transmitting unit for multicasting the media data packets, wherein the media data packets generated by the transmission protocol respectively include a packet header and a payload, and the packet header can include information on a fast startup.

### TECHNICAL FIELD

The present invention relates to a device and method for transmitting and receiving broadcast signals.

### BACKGROUND ART

With the development of digital technology and communication technology, distribution and demand of audio/video-oriented multimedia contents are rapidly expanding in various areas such as broadcasting, movies, Internet and personal media. In addition, as the size of TV screens at home increases with the development of display technology, ultra high definition (UHD) broadcasting services are increasingly discussed.

Regarding a broadcast service, a multicast transmission scheme for transmitting the same content to a plurality of users is effective because it may take advantage of both unicast and broadcast. However, the conventional multicast transmission scheme is available only within a single network, and cannot support a multicast service between heterogeneous networks. In addition, when file-based multicast content is transmitted in a real-time IP multicast broadcasting environment, a long time is required for initialization and audio/video (AV) startup operation of the receiver.

### DISCLOSURE

### Technical Problem

An object of the present invention is to provide a multicast signal transmission method and device which are capable of improving transmission efficiency.

Another object of the present invention is to provide a transmission device and method for providing a multicast service over a broadcast network.

It is another object of the present invention to provide a device and method for quickly starting playback in a receiver for a multicast service.

### Technical Solution

In one aspect of the present invention, provided herein is a multicast transmission method including receiving media data, packetizing the received media data into media data packets using a delivery protocol, and multicasting the media data packets, wherein each of the media data packets generated by the delivery protocol includes a packet header and a payload, wherein the packet header includes information about fast startup.

The fast startup may support fast presentation of the media data using a single building block, the single building block including a Media Presentation Description (MPD), an initialization segment file, and an ISO base media file format (ISOBMFF) file.

The ISOBMFF file may include a segment type box (styp), a segment index box (sidx), a movie fragment box (moof), and a media data box (mdat), wherein the mdat box may selectively include only an I frame of the media data.

The delivery protocol may be Quick UDP Internet Connections (QUIC), wherein the packet header may include at least one of information about whether the fast startup is supported, a representation ID of the media data, a code point, and QUIC presentation time stamp (PTS) information.

The MPD may include a descriptor indicating whether a representation belonging to the media data supports the fast startup.

In another aspect of the present invention, provided herein is a multicast transmission apparatus including a receiver configured to receive media data, a packetizer configured to packetize the received media data into media data packets using a delivery protocol, and a transmitter configured to multicast the media data packets, wherein each of the media data packets generated by the delivery protocol includes a packet header and a payload, wherein the packet header includes information about fast startup.

The fast startup may support fast presentation of the media data using a single building block, the single building block including a Media Presentation Description (MPD), an initialization segment file, and an ISO base media file format (ISOBMFF) file.

The ISOBMFF file may include a segment type box (styp), a segment index box (sidx), a movie fragment box (moof), and a media data box (mdat), wherein the mdat box may selectively include only an I frame of the media data.

The delivery protocol may be Quick UDP Internet Connections (QUIC), wherein the packet header may include at least one of information about whether the fast startup is supported, a representation ID of the media data, a code point, and QUIC presentation time stamp (PTS) information.

The MPD may include a descriptor indicating whether a representation belonging to the media data supports the fast startup.

In another aspect of the present invention, provided herein is a multicast reception method including receiving media data packets according to a delivery protocol, wherein each of the media data packets generated by the delivery protocol includes a packet header and a payload, and the packet header includes information about fast startup, and a decoder for acquiring information about the fast startup and performing the fast startup by decoding the received media data packets, wherein the fast startup supports fast presentation of the media data using a single building block, the single building block including a Media Presentation Description (MPD), an initialization segment file, and an ISO base media file format (ISOBMFF) file, wherein the ISOBMFF file includes a segment type box (styp), a segment index box (sidx), a movie fragment box (moof), and a media data box (mdat), wherein the mdat box selectively includes only an I frame of the media data.

The delivery protocol may be Quick UDP Internet Connections (QUIC), wherein the packet header may include at least one of information about whether the fast startup is supported, a representation ID of the media data, a code point, and QUIC presentation time stamp (PTS) information.

The MPD may include a descriptor indicating whether a representation belonging to the media data supports the fast startup.

In another aspect of the present invention, provided herein is a multicast reception apparatus including a receiver configured to receive media data packets according to a delivery protocol, wherein each of the media data packets generated by the delivery protocol includes a packet header and a payload, and the packet header includes information about fast startup, and a decoder configured to acquire information about the fast startup and perform the fast startup by decoding the received media data packets, wherein the fast startup supports fast presentation of the media data using a single building block, the single building block including a Media Presentation Description (MPD), an initialization segment file, and an ISO base media file format (ISOBMFF) file, wherein the ISOBMFF file includes a segment type box (styp), a segment index box (sidx), a movie fragment box (moof), and a media data box (mdat), wherein the mdat box selectively includes only an I frame of the media data.

The delivery protocol may be Quick UDP Internet Connections (QUIC), wherein the packet header may include at least one of information about whether the fast startup is supported, a representation ID of the media data, a code point, and QUIC presentation time stamp (PTS) information, wherein the MPD may include a descriptor indicating whether a representation belonging to the media data supports the fast startup.

### Advantageous Effects

According to an embodiment of the present invention, transmission efficiency of a broadcast system may be enhanced.

According to an embodiment of the present invention, a multicast service may be provided between heterogeneous networks.

According to an embodiment of the present invention, playback for a multicast service in a receiver may be started quickly.

### DESCRIPTION OF DRAWINGS

FIG. 1 is a diagram illustrating network architecture according to one embodiment of the present invention.

FIG. 2 is a diagram illustrating a content network according to an embodiment of the present invention.

FIG. 3 is a diagram illustrating a case where a content network according to an embodiment of the present invention includes a satellite relay.

FIG. 4 is a diagram illustrating a case where a content network according to an embodiment of the present invention includes a content delivery network (CDN).

FIG. 5 is a diagram illustrating a wired multicast network according to an embodiment of the present invention.

FIG. 6 is a diagram illustrating a mobile multicast network according to an embodiment of the present invention.

FIG. 7 is a diagram illustrating a user network according to an embodiment of the present invention.

FIG. 8 is a diagram illustrating network architecture for ABR multicast according to an embodiment of the present invention.

FIG. 9 is a diagram illustrating a protocol for an adaptive multicast stream according to an embodiment of the present invention.

FIG. 10 is a diagram illustrating a protocol for adaptive multicast streaming according to an embodiment of the present invention.

FIG. 11 is a diagram illustrating a protocol for signaling and control messages according to an embodiment of the present invention.

FIG. 12 is a diagram illustrating a protocol for signaling and control messages according to an embodiment of the present invention.

FIG. 13 is a diagram illustrating a protocol for transmitting media data over an IP network according to an embodiment of the present invention.

FIG. 14 is a diagram illustrating a media delivery protocol for IP multicasting according to an embodiment of the present invention.

FIG. 15 is a diagram illustrating a media delivery protocol for IP multicasting according to an embodiment of the present invention.

FIG. 16 is a diagram illustrating a media delivery protocol for IP multicasting according to an embodiment of the present invention.

FIG. 17 illustrates a DASH transmission scheme according to an embodiment of the present invention.

FIG. 18 is a diagram illustrating a structure of a DASH segment according to an embodiment of the present invention.

FIG. 19 is a diagram illustrating a structure of a DASH segment, a generating order, and a parsing order according to an embodiment of the present invention.

FIG. 20 is a diagram illustrating a user network and an MPD according to an embodiment of the present invention.

FIG. 21 is a diagram illustrating details of an MPD according to an embodiment of the present invention.

FIG. 22 illustrates an MPD for fast startup according to an embodiment of the present invention.

FIG. 23 is a diagram illustrating a network configuration for multicast according to an embodiment of the present invention.

FIG. 24 is a diagram illustrating a process of generating a DASH segment according to an embodiment of the present invention.

FIG. 25 is a diagram illustrating a QUIC protocol stack according to an embodiment of the present invention.

FIG. 26 is a diagram illustrating a multicast method to which the QUIC protocol is applied according to an embodiment of the present invention.

FIG. 27 is a diagram illustrating QUIC header extension according to an embodiment of the present invention.

FIG. 28 is a diagram illustrating a receiver structure according to an embodiment of the present invention.

FIG. 29 is a diagram illustrating a content server, a multicast server and a multicast receiver according to an embodiment of the present invention.

FIG. 30 illustrates a method of operating a multicast server according to an embodiment of the present invention.

FIG. 31 illustrates a method of operating a multicast receiver according to an embodiment of the present invention.

### BEST MODE

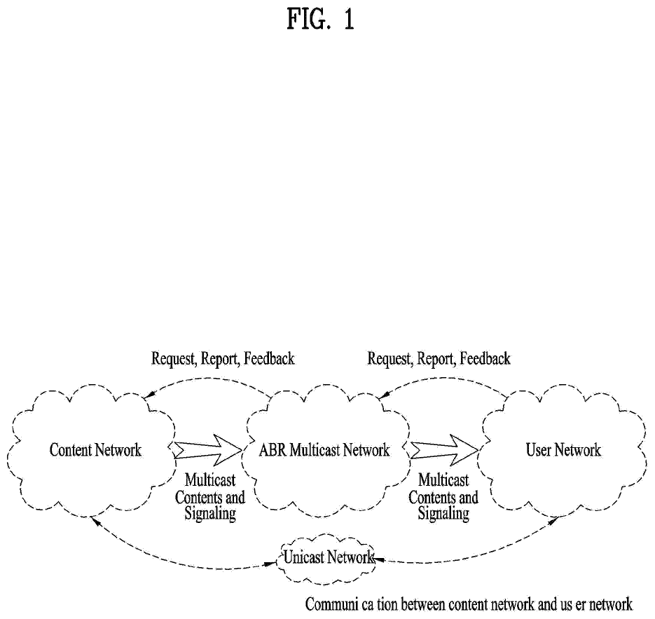

FIG. 1 is a diagram illustrating network architecture according to one embodiment of the present invention. As shown in FIG. 1, a network for adaptive media streaming may include a content network, an adaptive bit rate (ABR) multicast network, and a user network. This is a functional classification of networks used to support adaptive media streaming in an Internet Protocol (IP)-based multicast network. Each network may also connect to an additional network for supporting functions other than adaptive media streaming For example, the content network and the user network may each connect to a unicast network for unicast services.

The user network may transmit a request, report, and feedback for content to be received to the ABR multicast network. The ABR multicast network may transmit a request, report, and feedback to the content network based on the information received from the user network. The content network may transmit multicast content and signaling information to the ABR multicast network based on the information received from the ABR multicast network. The ABR multicast network may transmit the received multicast content and signaling information to the user network to provide a multicast service.

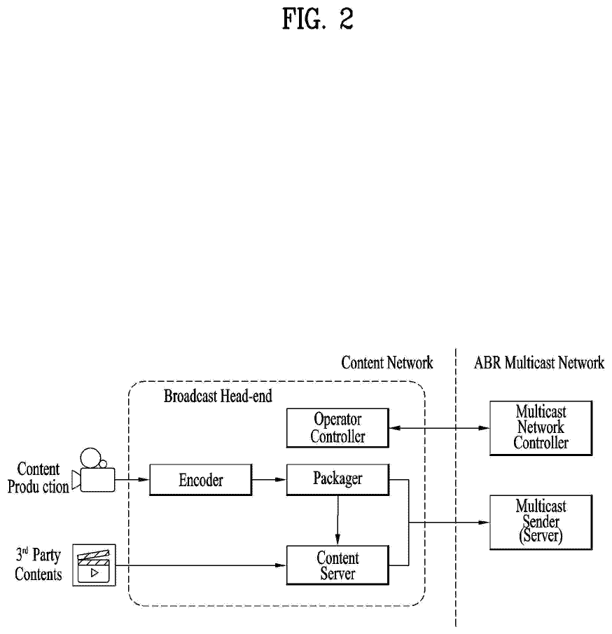

FIG. 2 is a diagram illustrating a content network according to an embodiment of the present invention. The content network may serve to generate, collect, and package content for adaptive multicast streaming, and may include various content sources. The content network may include a head-end of a broadcaster that provide terrestrial and cable broadcasting to provide broadcast content. The broadcaster head-end may include at least one of an encoder to encode content generated in content production, a packager to convert the encoded content, or a content server to store the content.

In addition, the content network may further include a satellite reception network to receive produced services from a geographically remote area. The content network may also include a content server to provide pre-stored content. The content network may include, besides the content server, a Content Delivery Network (CDN) to provide media transfer. Accordingly, the content network may generate and transmit a signaling message, a control message, and the like which are related to the content.

A separate signaling message or control message may be exchanged between several nodes belonging to the content network for proper interaction among the content, signaling message, control message, and the like, and these messages may not be delivered to other external networks. The signaling message or control message that is not transmitted to the external network may be referred to as internal network signaling.

As described above, the content network may include a broadcaster head-end. Content generated by the broadcaster may be subjected to encoding and packaging, and may then be delivered to a multicast transmitter so as to be multicast or be stored in the content server and delivered to the multicast transmitter when necessary. Components included in the broadcaster head-end of the content network are described below.

First, an encoder included in the broadcaster head-end encodes content. A packager included in the broadcaster head-end may convert the encoded content and data into a format suitable for multicast transmission. The format suitable for multicast transmission may be, for example, a media segment created by dividing one content item. In addition, when necessary, the packager may generate signaling that can be received by the receiver or a device belonging to a network. The media segment generated by the packager may be delivered directly to the multicast sender and multicast. However, in the case where the media segment is data that need not be delivered immediately, it may be stored in the content server. The content server included in the broadcaster head-end may store media data and related signaling. The content server may also store third party content generated by a third party and utilize the same for multicast if necessary. Here, the content stored in the content server may not require a separate encoding operation. Accordingly, the content server may store the media segments and the file formed by encoding or packaging the content, and may transmit the same when there is a transmission request. According to an embodiment, an encoding result of the media data may be stored in the content server, and a separate packaging operation may be required depending on the type of the transmission network. An operator controller included in the broadcaster head-end may manage content production, the content server, and the like, and manage and control a series of operations related to multicasting. The operator controller may collect control and signaling data for a plurality of devices and nodes in the content network and, if necessary, transmit the control and signaling data to the multicast network. Thereby, the operator controller may enable the multicast network to perform signaling and control related to multicast. In addition, the operator controller may receive and process unicast information transmitted from a decoding device or a player to use the same for multicast.

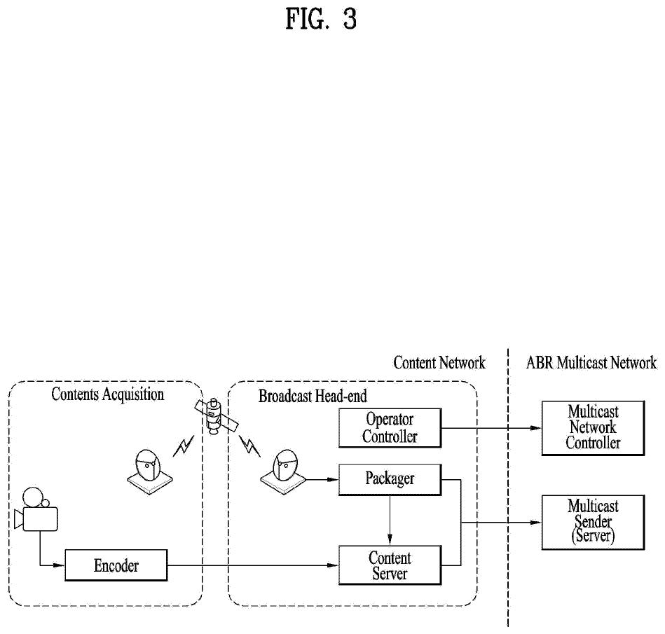

FIG. 3 is a diagram illustrating a case where a content network according to an embodiment of the present invention includes a satellite relay. The content network provided with a satellite relay may include an encoder, a satellite transmitter, a satellite receiver, a packager, a content server, and an operator controller. The head-end of a broadcaster providing terrestrial and cable broadcasting may include a satellite reception network for receiving services of geographically remote content producers. The satellite transmitting side may be the head-end of another broadcaster. In this case, a satellite transmission/reception network to which head-ends of a plurality of broadcasters are connected may be included in the content network. The content received via the satellite system may be subjected to encoding and packaging, and may then be delivered to the multicast sender so as to be multicast or be stored in the content server so as to be delivered to the multicast sender when necessary. The encoder of the content network in which the satellite relay is included may perform encode content. Here, the encoder may be connected to a satellite transmission device for relaying broadcast data to a satellite. The satellite relay system of the content network that includes the satellite relay may be used to provide live broadcasting for a geographically distant place. For example, overseas sports, concerts, news, and the like may be broadcast in real time through the satellite relay system. For this purpose, a separate satellite transmission related protocol and transmission scheme may be used. Data passed through the satellite transmission/reception system is delivered to the packager. The packager of the content network including the satellite relay is configured as illustrated in the previous drawing. The content server of the content network including the satellite relay may store media data and related signaling. In live broadcasting to a geographically distant place, the data passed through the packager may be transmitted directly to the multicast sender, but the data and related signaling may be stored in the head-end of the broadcaster for later use for the content. Detailed description thereof has been given with reference to the previous drawings. The description of the operator controller of the content network including the satellite relay has been given with reference to the previous drawings.

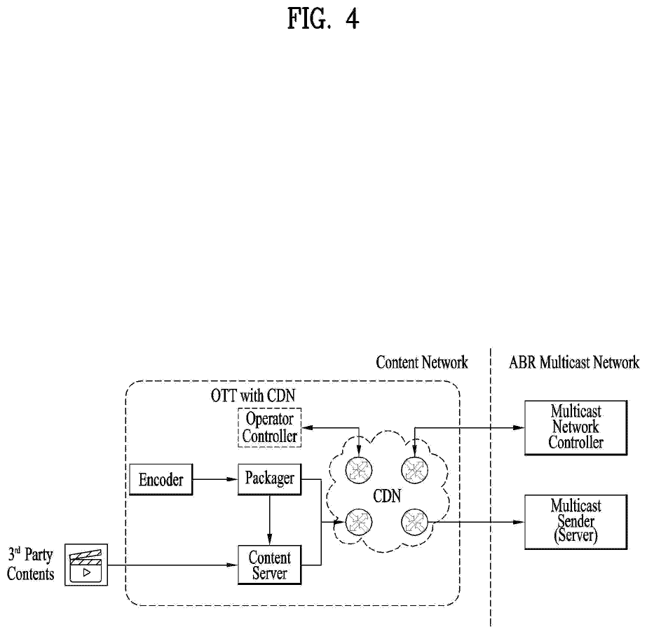

FIG. 4 is a diagram illustrating a case where a content network according to an embodiment of the present invention includes a content delivery network (CDN). Over the top (OTT) for providing video content using the IP network may be considered as one embodiment of the content network. In the case of OTT, the CDN may be connected for efficient use of network resources. The content network including the CDN may include an encoder, a packager, a content server, an operator controller, and the CDN. The content of the OTT may be delivered to the CDN through encoding and packaging. In addition, the encoded and packaged content may be stored in the content server and then delivered to the CDN in response to a request for the content. The content delivered to the CDN may be delivered to the multicast sender. According to an embodiment, the content of the OTT may be delivered to the multicast sender directly without assistance of the CDN and multicast. The encoder of the OTT may encode the content. The OTT may provide a live service or produce content to be stored in the content server. The packager of the OTT is configured as described above with reference to the previous drawings. The content server of the OTT may store media data and relevant signaling to be provided by the OTT. The content server may also store third party content generated and utilize the same for multicast if necessary. Here, the content stored in the content server may not require a separate encoding operation. Accordingly, the content server may store the media segment and the file formed by encoding or packaging the content, and may transmit the same when there is a transmission request. According to an embodiment, an encoding result of the media data may be stored in the content server, and a separate packaging operation may be required depending on the type of the transmission network. The operator controller may collect control and signaling data for a plurality of devices and nodes in the content network and, if necessary, transmit the control and signaling data to the multicast network. Thereby, the operator controller may enable the multicast network to perform signaling and control related to multicast. In addition, the operator controller may receive and process unicast information transmitted from a decoding device or a player to use the same for multicast. The OTT and CDN may each include a separate operator controller. The operator controller included in the OTT and the operator controller included in the CDN may communicate with each other.

The ABR multicast network is a network that multicasts content delivered from the content network over the IP network. Here, the IP network may correspond to either a managed network where QoS is managed by a network provider and unauthorized traffic can be restricted, or an unmanaged network where unauthorized traffic is not restricted. In addition, the IP network may be connected in a wired or wireless manner by devices included in the multicast network or the user network. In using the IP network for multicast, the IP network connected to the content network may be different from the IP network connected to the user network. That is, the content network and the user network may be connected to separate IP networks. In this case, the separate IP networks may conform to a connection protocol between Internet Service Providers (ISP) providing the respective networks. Even in this case, the multicast content is transparent between the transmitter and the receiver. That is, the output data of the transmitter is the same as the input data of the receiver, even though it passes through several ISP networks and nodes on the network.

The multicast network for transmitting and receiving multicast streams may include a multicast sender (server), a multicast receiver (client), and a multicast network controller. The multicast network may include a plurality of networks, depending on the location or connection status of the sender and receiver of the network for multicast. In addition, a separate protocol may be used for each network.

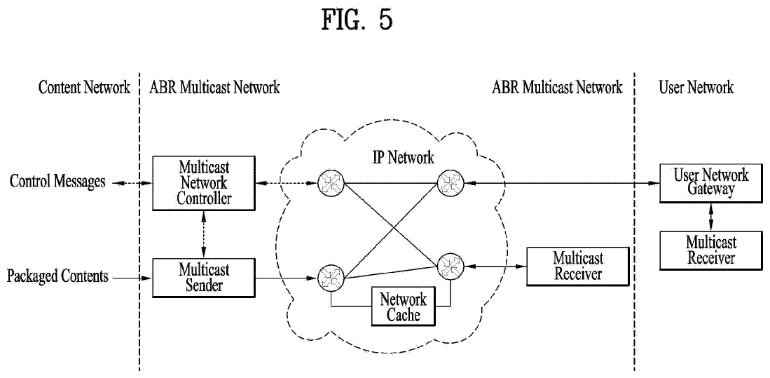

FIG. 5 is a diagram illustrating a wired multicast network according to an embodiment of the present invention. Multicast streams may be delivered over a wired IP network. A network provided by an ISP may be used between the multicast sender and the multicast receiver. According to an embodiment, the multicast stream may be delivered over an IP network managed by a plurality of ISPs, and the management entities of the multicast sender, receiver, controller and IP network may be different from each other. In this case, transmission of the multicast stream may conform to a connection protocol corresponding to each ISP.

The multicast sender included in the multicast network may transmit content data to each multicast receiver. The multicast sender may receive packaged content from the content network and transmit the packaged content to a plurality of multicast receivers using the multicast protocol. The multicast receiver included in the multicast network may receive the content data transmitted from the multicast sender and deliver the content data to a decoding device capable of reproducing the content data. The multicast receiver may cache the content data to allow the decoding device to reproduce the content data efficiently. According to an embodiment, the multicast receiver may be configured in the same apparatus as the decoding device. In an embodiment, a multicast stream may be received through a gateway of the user network. In this case, the multicast receiver may be a component of the user network.

The multicast network controller included in the multicast network may control content transmission of the multicast sender and related session information. In addition, the multicast network controller may manage and transmit signaling information for configuration of each of the multicast sender and multicast receivers. The multicast network controller may be connected to each of the multicast sender and multicast receivers using a protocol separate from that of the multicast content. According to an embodiment, the multicast network controller may be connected only to the multicast sender, and signaling information transmitted to the multicast receiver may conform to the same protocol as that of the multicast content.

A network cache included in the multicast network may include a node or a device functioning as a cache between the multicast sender and the multicast receivers. In a multicast transmission, the network cache may store a proper range of content for efficient use of network resources, and deliver a multicast stream to the multicast receiver. According to an embodiment, the network cache may perform an update procedure for the multicast sender and the cached content.

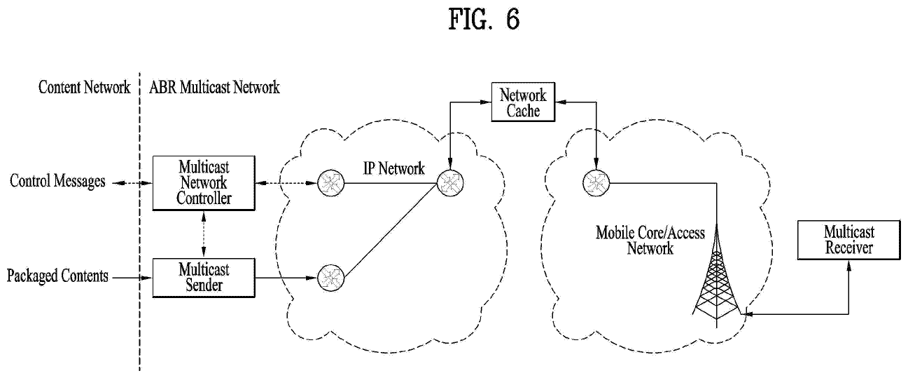

FIG. 6 is a diagram illustrating a mobile multicast network according to an embodiment of the present invention. A multicast stream may be delivered over a wired IP network. However, for a mobile receiver, the multicast stream may be delivered over a mobile access network. For IP multicast, a network that supports IP transport may be used as the mobile access network. In addition, the mobile access network may support multicast to provide a multicast stream to a plurality of mobile receivers.

The multicast sender included in the multicast network may transmit content data to each multicast receiver. The multicast sender may receive packaged content from the content network and transmit the packaged content to a plurality of multicast receivers using a multicast protocol. The multicast receiver included in the multicast network may receive the content data transmitted from the multicast sender and deliver the content data to a decoding device capable of reproducing the content data. The multicast receiver connected to the mobile access network may receive a radio signal for the mobile access network. According to an embodiment, the multicast receiver connected to the mobile access network may be connected to the decoding device according to a separate wireless access protocol. The multicast receiver may cache the content data to allow the decoding device to reproduce the content data efficiently. According to an embodiment, the multicast receiver may be configured in the same apparatus as the decoding device.

The multicast network controller included in the multicast network may control content transmission of the multicast sender and related session information. In addition, the multicast network controller may manage and transmit signaling information for configuration of each of the multicast sender and multicast receivers. The multicast network controller may be connected to each of the multicast sender and multicast receivers using a protocol separate from that of the multicast content. According to an embodiment, the multicast network controller may be connected only to the multicast sender, and signaling information transmitted to the multicast receiver may conform to the same protocol as that of the multicast content. In addition, the IP network and the mobile access network may each include a multicast network controller. In this case, the multicast network controller may transmit and receive control and signaling information about the corresponding network. Each of the multicast network controllers may use a separate protocol to perform communication between the multicast network controllers.

The network cache included in the multicast network may include a node or a device functioning as a cache between the multicast sender and the multicast receivers. The network cache may be included in each of a plurality of networks constituting the multicast network, and a plurality of network caches may be included in each network. In addition, some nodes of each network may simultaneously perform the cache function. The network cache may store a proper range of content to efficiently use network resources in multicast transmission, and deliver a multicast stream to the multicast receivers. According to an embodiment, the network cache may perform an update procedure for the multicast sender and the cached content.

The user network may be referred to as a network to receive data from the multicast network and deliver the same to a device to consume the content included in the data. The user network may be implemented in various forms according to the configuration of the user network and the type of a service provided by multicasting. According to an embodiment, the multicast receiver described above may be included in the user network. When the multicast receiver is included in the user network, the multicast receiver may receive multicast content through a device serving as a gateway or proxy included in the user network. In this case, the gateway or proxy may be considered as a component of the ABR multicast network.

The multicast receiver may serve as a server or a multicast sender in the user network. Accordingly, the decoding device included in the user network may consume the multicast content, and may enable multicast streaming even when the decoding device cannot directly receive the multicast content.

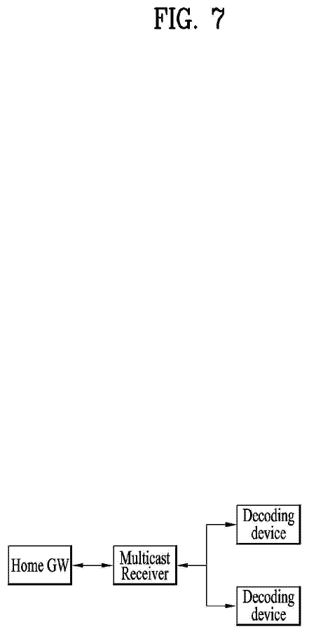

FIG. 7 is a diagram illustrating a user network according to an embodiment of the present invention. As an embodiment of the user network, a home network may be considered. The multicast receiver may directly receive data transmitted through multicasting, or a home gateway belonging to the home network may receive the data and deliver the data to the multicast receiver.

When the home network includes a plurality of devices, the home gateway may receive data from the ABR multicast network. The home gateway may transmit and receive data to and from an external network, while serving as a proxy. In the case where the home gateway operates as a proxy, the home gateway may cache data to be delivered to the multicast receiver.

The multicast receiver may be included in the ABR multicast network described above, or may be located inside the home network due to the configuration of the network. According to the configuration of the home network, the multicast receiver may serve as a proxy. In the case where the multicast receiver cannot play the multicast stream directly, a decoding device capable of playing the multicast stream may be additionally connected to the multicast receiver. In addition, the multicast receiver may transmit the multicast stream in connection with a plurality of decoding devices.

The decoding device may be defined as a device to play a multicast stream and provide the multicast stream to a user. A plurality of decoding devices may connect to the multicast receiver. The decoding devices may transmit and receive data in a unicast or multicast manner. The decoding device may connect to a unicast network as well as the multicast network to receive a multicast stream. The decoding devices may transmit a request, a report, or the like to the content network or the ABR multicast network. In some embodiments, besides the decoding device, a decoding module and a display screen may be included in the home network as separate devices. The decoding device may also be configured together with the multicast receiver as a single device.

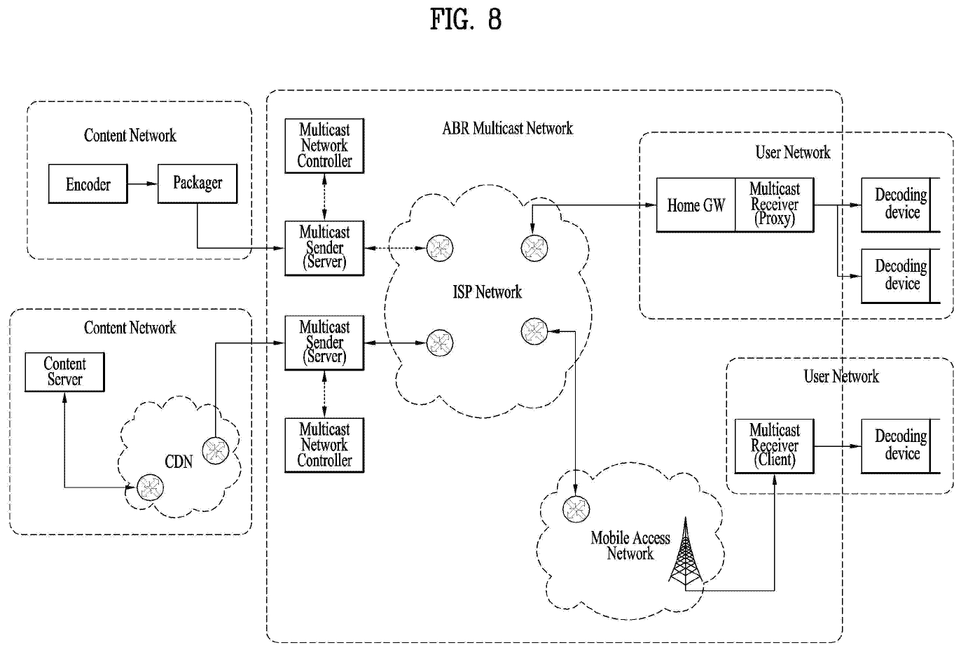

FIG. 8 is a diagram illustrating network architecture for ABR multicast according to an embodiment of the present invention. The figure illustrates an example of overall network architecture for adaptive media streaming. The network architecture for adaptive media streaming may include a content network, an ABR multicast network, and a user network. Details of each of the networks are the same as those described above with reference to the previous drawings. The node or entity defined in the present invention may be a logical constituent. According to an embodiment, each node may be configured as a separate device, or may operate together with a neighboring node in the same apparatus. As shown in the figure, a plurality of networks may be connected to each other and exchange signaling and management information with each other for efficient multicast streaming.

Hereinafter, network interfaces and protocols for adaptive media streaming will be described. The protocols may be classified into a media protocol by which media data is actually transmitted, and a signaling protocol for controlling each node or entity to transmit media data or transmitting configuration information about the media data to various nodes and entities including a receiver. Signaling and control information may be transmitted by the signaling protocol. However, in the case where the receiver receives with media content by a single connection, a separate signaling path may not be configured. In this case, the signaling and control information may be delivered by the media protocol.

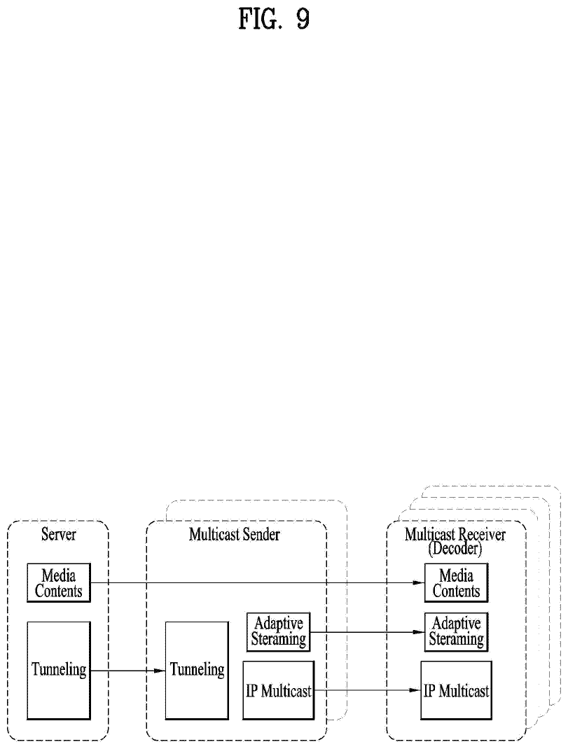

FIG. 9 is a diagram illustrating a protocol for adaptive multicast streaming according to an embodiment of the present invention. As shown in the figure, a multicast receiver may include the same devices and modules as a decoder. Media content created in the content network or stored in a server may be delivered to the decoding device of a user. The media content may be transmitted in a multicast manner so as to be delivered to a plurality of users.

In the adaptive multicast streaming environment, creation and multicast transmission/reception of content may be performed separately. Therefore, a protocol for delivering created content to a node and an entity configured to perform multicast transmission and a protocol for transmitting and receiving the content in the adaptive streaming format in the multicast manner may be defined, respectively. In the figure, the node and the entity are shown as multicast senders. Content data passes through a plurality of nodes or entities, and an appropriate protocol is needed between the nodes or the entities. In this case, for a protocol on a node or an entity, a protocol for efficiently delivering data to the next node in real time may be used. This protocol may be referred to as a tunneling protocol. Accordingly, as shown in the figure, a tunneling protocol may be defined between the server and a multicast sender. In this case, the media content is delivered as a payload of the tunneling protocol, but it should be noted that the tunneling protocol can operate regardless of the format of the media content.

In the multicast sender, a protocol for supporting adaptive streaming for multicast receivers may be defined, and the IP multicast scheme may be employed to deliver the adaptive streaming to a plurality of multicast receivers. Depending on the protocol of adaptive streaming, the IP multicast scheme may be defined as a combination of TCP/IP and UDP/IP.

When the multicast receiver can serve as a decoder and player, the multicast receiver may obtain adaptive streaming data by receiving an IP multicast packet, decode data corresponding to the media content format from the data and play decoded data.

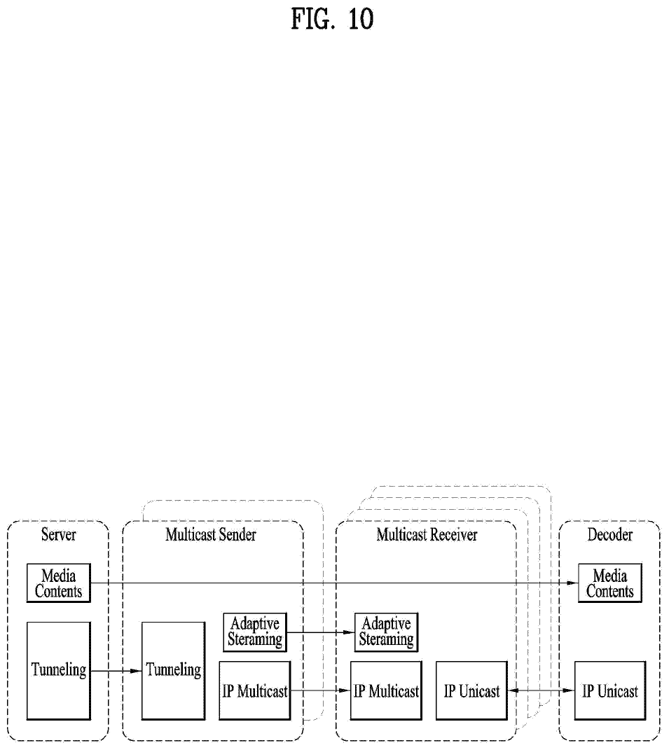

FIG. 10 is a diagram illustrating a protocol for adaptive multicast streaming according to an embodiment of the present invention. As shown in the figure, a multicast receiver may be configured as a device or module separate from the decoder (media player). Media content created in the content network or stored in a server may be delivered to the decoding device of a user. The media content may be transmitted in a multicast manner so as to be delivered to a plurality of users.

In the adaptive multicast streaming environment, creation and multicast transmission/reception of content may be performed separately. Therefore, a protocol for delivering created content to a node and an entity configured to perform multicast transmission and a protocol for transmitting and receiving the content in the adaptive streaming format in the multicast manner may be defined, respectively. In the figure, the node and the entity are shown as multicast senders. Content data passes through a plurality of nodes or entities, and an appropriate protocol is needed between the nodes or the entities. In this case, for a protocol on a node or an entity, a protocol for efficiently delivering data to the next node in real time may be used. This protocol may be referred to as a tunneling protocol. Accordingly, as shown in the figure, a tunneling protocol may be defined between the server and a multicast sender. In this case, the media content is delivered as a payload of the tunneling protocol, but it should be noted that the tunneling protocol can operate regardless of the format of the media content.

In the multicast sender, a protocol for supporting adaptive streaming for multicast receivers may be defined, and the IP multicast scheme may be employed to deliver the adaptive streaming to a plurality of multicast receivers. Depending on the protocol of adaptive streaming, the IP multicast scheme may be defined as a combination of TCP/IP and UDP/IP.

When the multicast receiver and the decoder (player) are configured as separate devices or modules, the multicast receiver may obtain adaptive streaming data by receiving an IP multicast packet and deliver the same to the decoder. Here, an IP unicast protocol may be used between the multicast receiver and the decoder. The content data received by the multicast receiver may be delivered to the decoder by the IP unicast protocol, and the decoder may decode and play data corresponding to the received media content format.

Hereinafter, a protocol for signaling and control messages will be described. Transmission of signaling and control messages may be defined by a protocol distinct from the protocol for media content transmission in order to provide transmission control, scheduling, configuration information, and the like when each node and each entity perform adaptive streaming Depending on a case where each node and each entity are connected, the protocol may be defined as a separate protocol. In the above-described network architecture, a signaling and control message may be included and transmitted in the protocol for transmission of media content. However, such a signaling and control message conforms to a protocol for media content delivery.

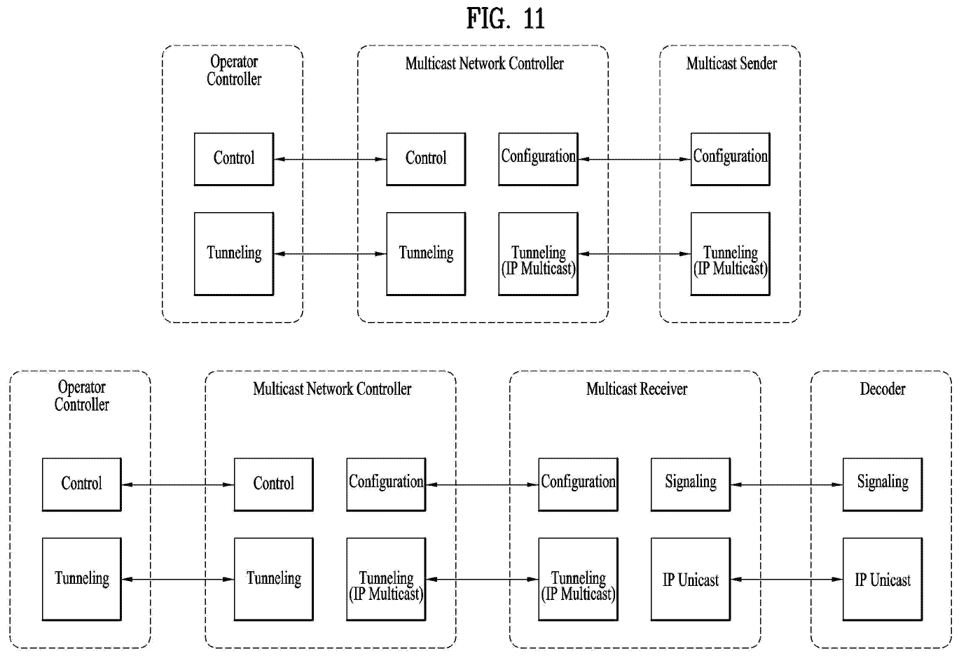

FIG. 11 is a diagram illustrating a protocol for signaling and control messages according to an embodiment of the present invention. In the above-described network architecture, a control protocol may be defined between an operator controller included in the content network and a network controller included in the multicast network. The network controller may send a response or report message for a control message to the operator controller in order for the operator controller to generate control and management messages. Thus, the tunneling protocol for sending a control message may be bi-directionally configured. A single operator controller may transmit and receive control messages to and from a plurality of multicast network controllers. In addition, each of the multicast network controllers may be managed by a separate management entity.

The network controller may deliver configuration related information about the network to the multicast sender and the multicast receiver. The network controller may deliver configuration information about network resources, information about mapping between the nodes of the network, routing information, and the like. It may also deliver configuration information received from the operator controller to the multicast sender or the multicast receiver. In this process, the protocol for transmission from the multicast network controller to the multicast sender may be distinguished from the protocol for transmission to the multicast receiver. The upper part of the figure shows the protocol for transmission from the network controller to the multicast sender, and the lower part of the figure shows the protocol for transmission from the network controller to the multicast receiver.

In addition, IP multicast may be used to deliver a configuration message from one network controller to a plurality of multicast senders and multicast receivers. Connection information, statistical information, and the like collected by the multicast senders and the multicast receivers may be reported to the multicast network controller. Since this process can be carried out independently by each of the multicast senders and multicast receivers, a unicast protocol may be used. This set of control information, configuration information, and the like may be updated dynamically and be transmitted immediately or by scheduling.

The multicast receiver may use a signaling protocol for transmitting the received adaptive streaming data to a decoding device. Here, an IP unicast protocol may be defined to provide separate information to individual decoding devices. In addition, the decoding device may transmit signaling of a request of the decoding device to the multicast receiver using the IP unicast protocol. Thus, the protocol may be defined as a bidirectional protocol between the multicast receiver and the decoding device.

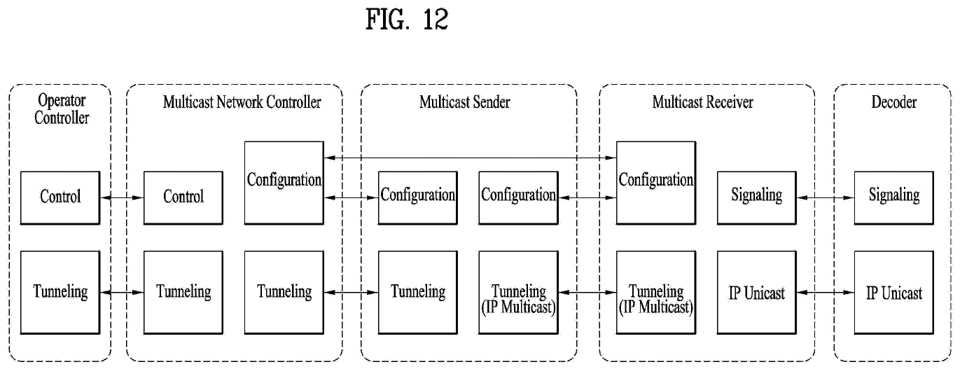

FIG. 12 is a diagram illustrating a protocol for signaling and control messages according to an embodiment of the present invention. As shown in the figure, the multicast network controller may be connected to the multicast receiver via a multicast sender rather than being connected directly to the multicast receiver.

The network controller may deliver configuration related information about the network to the multicast sender and the multicast receiver. The network controller may deliver configuration information about network resources, information about mapping between the nodes of the network, routing information, and the like. It may also deliver configuration information received from the operator controller to the multicast sender or the multicast receiver. However, since the multicast controller is connected only to the multicast sender and not to the multicast receiver, the multicast sender may forward the configuration message delivered from the network controller to the multicast receiver. For a protocol or message set related to configuration in the multicast network controller, the protocol for transmission to the multicast sender may be distinguished from the protocol for transmission to the multicast receiver.

In addition, IP multicast may be used to deliver a configuration message from one network controller to a plurality of multicast senders and multicast receivers. Connection information, statistical information, and the like collected by the multicast senders and the multicast receivers may be reported to the multicast network controller. Since this process can be carried out independently by each of the multicast senders and multicast receivers, a unicast protocol may be used. This set of control information, configuration information, and the like may be updated dynamically and be transmitted immediately or through scheduling.

Information such as a report to be transmitted from the multicast receiver to the multicast network controller may be delivered to the multicast network controller via the multicast sender. That is, the multicast sender may forward a report message or the like to be delivered from the multicast receiver to the multicast network controller. Operations of the other protocols may be the same as those in the above-described drawings.

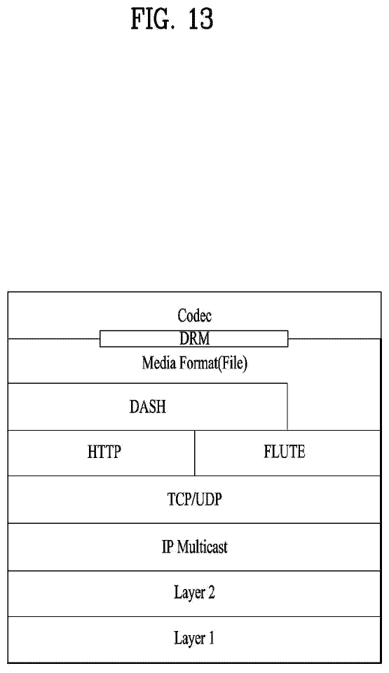

FIG. 13 is a diagram illustrating a protocol for transmitting media data over an IP network according to an embodiment of the present invention. A protocol and a packet format may be determined according to each layer. Each protocol may be configured independently or specific protocols may be combined for interoperability. The operation of the encoder of compressing and converting the collected video and audio data into an appropriate codec and delivering a packager may be performed as internal data processing of a transmission system. For multicasting of the video and audio data, an efficient codec may be used. A codec such as High Efficiency Video Coding (HEVC) or Advanced Video Coding (AVC) may be used for the video data, and an audio codec such as Advanced Audio Coding (AAC), Audio Compression 4 (AC4), or Moving Picture Experts Group-H (MPEG-H) may be used for the audio data.

Each codec may be packaged in a form suitable for transmission or storage. For this purpose, a format such as ISO Base Media File Format (ISOBMFF), Common Media Application Format (CMAF), or MPEG-2 TS (Transport Stream) may be used. In the process of packaging content data encoded with a codec, Digital Rights Management (DRM) may be added to allow only a specific receiver to play the contents, and an authentication key value used in the DRM may be transmitted on a separate link or channel.

For media data configured in a file format, a protocol capable of transmitting files directly, such as File Delivery over Unidirectional Transport (FLUTE), may be used according to transmission scheme. In addition, a protocol supporting adaptive streaming, such as Dynamic Adaptive Streaming over HTTP (DASH), may be used. A lower layer protocol may be used according to the configuration of FLUTE or DASH. For example, when DASH is used, HTTP may be used as a lower layer protocol, or FLUTE may be used as a lower layer protocol considering a DASH segment as a file.

For IP multicast, Transmission Control Protocol/Internet Protocol (TCP/IP) or User Datagram Protocol/Internet Protocol (UDP/IP) may be used according to the configuration of the upper layer protocol. Internet Group Management Protocol (IGMP) capable of managing subscription of a IP multicast group and the like may also be used in the multicast receiver. The Layer 2 protocol and Layer 1 protocol may be defined according to the transport links thereof. That is, optimized protocols may be configured according to links between the nodes and entities configured on a network. For example, in a Local Area Network (LAN) environment, Ethernet may be defined as a protocol for Layer 2, and Carrier Sense Multiple Access with Collision Detection (CSMA/CD) may be defined as protocol for Layer 1.

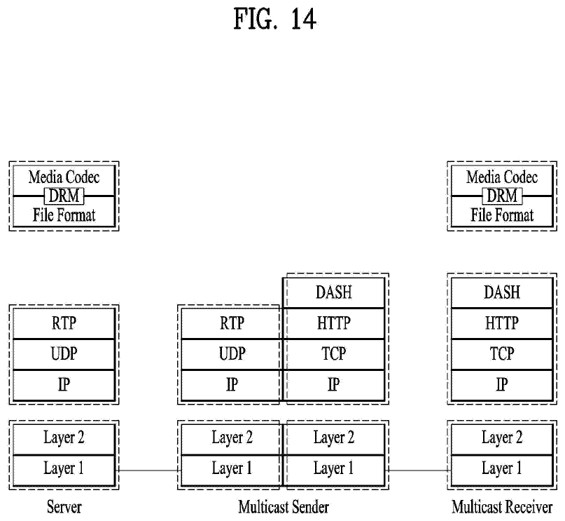

FIG. 14 is a diagram illustrating a media delivery protocol for IP multicasting according to an embodiment of the present invention. The media delivery protocol is a specific embodiment of a protocol according to a path through which media content is transmitted. In the illustrated case, the multicast receiver is configured with the same device and module as the decoder (media player).

Protocols used on the server for content are a media codec and a file format. The media codec may include a video codec, an audio codec or other encoding formats. The video codec may include a codec such as HEVC or AVC, and the audio codec may include a codec such as AAC, AC4, and MPEG-H. The protocol for the file format may be defined as a format for transmitting or storing a codec format in the form of a file. For this purpose, file formats such as ISOBMFF and CMAF may be used, and the format of MPEG-2 TS may be used when the existing broadcast network is connected. A plurality of file formats may be used in consideration of transmission efficiency.

For a protocol between the server and the multicast sender, a protocol for efficient delivery of file formats may be mainly defined. Therefore, data of the content created in the server may be delivered using a tunneling protocol. As the tunneling protocol, a real-time transmission protocol such as RTP may be mainly used, and other IP-based tunneling protocols which are available to the corresponding network may also be used. In this case, an existing protocol may be used or the definition of a field may be changed so as to be suitable for the network. In the multicast sender, a tunneling protocol may be defined at the input terminal to receive a file transferred from the server using the tunneling protocol. In this case, since the format for the file transmitted using the tunneling protocol is data to be delivered from the multicast sender to the multicast receiver, the tunneling protocol may operate regardless of the format of the data.

As the protocol between the multicast sender and the multicast receiver, a protocol for adaptive streaming may be mainly defined. This protocol may include a DASH-based protocol. For this purpose, the lower layer protocol is based on IP multicast. In order for DASH to operate, a protocol such as HTTP may be used together with DASH. In the case where a DASH segment is used in the form of a file, a file transfer protocol such as FLUTE may be configured. In addition, TCP/IP may be used for effective connection and multicast transmission of DASH/HTTP on the network.

The multicast receiver may use TCP/IP to receive a packet stream transmitted in a multicast manner In addition, the multicast receiver may use HTTP for a request for a packet stream, a response to the received data, and the like. When the multicast sender uses DASH for adaptive streaming, the multicast receiver may include a DASH client. Data that is adaptively streamed using DASH is configured in a file format transmitted from the server. Accordingly, the multicast receiver may use a file format related protocol capable of identifying the file format and a media codec capable of decoding the identified media format.

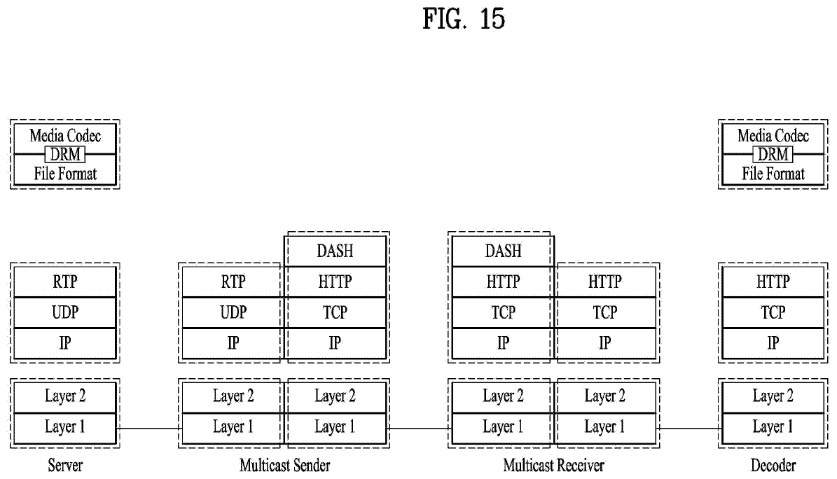

FIG. 15 is a diagram illustrating a media delivery protocol for IP multicasting according to an embodiment of the present invention. The media delivery protocol is a specific embodiment of a protocol according to a path through which media content is transmitted. This embodiment represents a case where the multicast receiver is configured as a device or module separate from the decoder (media player). Therefore, the multicast receiver needs a process of transmitting a received multicast stream to the decoding device (decoder).

The multicast receiver may use TCP/IP to receive a packet stream transmitted in a multicast manner In addition, the multicast receiver may use HTTP for a request for a packet stream, a response to the received data, and the like. When the multicast sender uses DASH for adaptive streaming, the multicast receiver may include a DASH client. The multicast receiver may serve as a proxy for data that is adaptively streamed using DASH. The multicast receiver may deliver the data to the decoding device. Since the number of decoding devices connected to the multicast receiver may be limited, the corresponding connection may be based on unicast transmission. Accordingly, the multicast receiver may use HTTP and TCP/IP as protocols for unicast connection.

The decoding device may use a unicast protocol to receive data transmitted from the multicast receiver. Data delivered by HTTP unicast may have a file format transmitted by the server. Accordingly, the decoding device may use a file format related protocol capable of identifying the file format and a media codec capable of decoding the identified media format. Operations of the other protocols may be the same as those in the embodiment described with reference to the previous drawings.

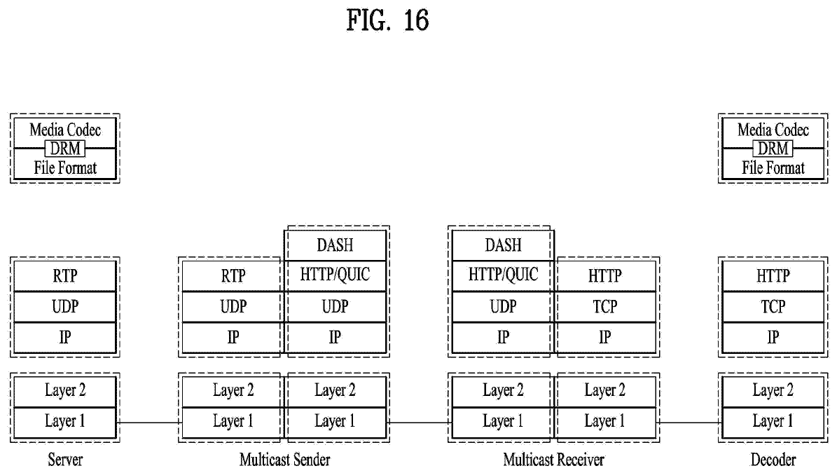

FIG. 16 is a diagram illustrating a media delivery protocol for IP multicasting according to an embodiment of the present invention. For transmission of the DASH segment, the Quick UDP Internet Connections (QUIC) protocol may be used. The multicast scheme using TCP/IP may incur delays in establishing connections and may not be suitable for immediate transmission of streaming data. In the QUIC based protocol, QUIC is responsible for a process of connection and flow control. In addition, QUIC may use HTTP/2, thereby addressing the issue of transmission delay incurred by the existing protocol HTTP. In addition, streaming data may be immediately transmitted using UDP/IP. Operations of the other protocols are the same as those in the above-described embodiment.

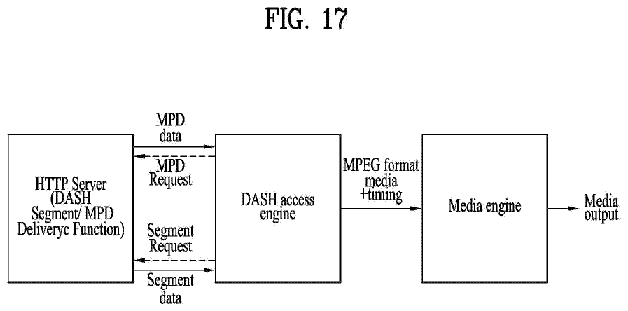

FIG. 17 illustrates a DASH transmission scheme according to an embodiment of the present invention. The DASH system may be implemented by transmission and reception of data between the HTTP server and the DASH client. The DASH client may include a DASH access engine and a media engine. In DASH, the HTTP server may divide content of various qualities into segments in a certain time unit and store the divided content in the server. The HTTP server may transmit the divided data unit at the request for media from the DASH client, which is a user device, using the HTTP protocol. Here, in consideration of the flexible HTTP network state, media contents of various qualities stored on the HTTP server may be selectively transmitted. This may allow the user to receive a seamless adaptive streaming service. A separate file including information about a timeline order and a quality order of the divided files described above is media presentation description (MPD). The MPD may provide the DASH client with information about the media data stored on the HTTP server. The MPD is an XML document and may include attributes such as URL, start time, content type, and the like assigned to each divided segment. The DASH client may request and receive an MPD file from the server prior to receiving the media file. Upon receiving the MPD file, the DASH client may request a segment file of the content stored on the HTTP server, by using the information about the media file included in the MPD.

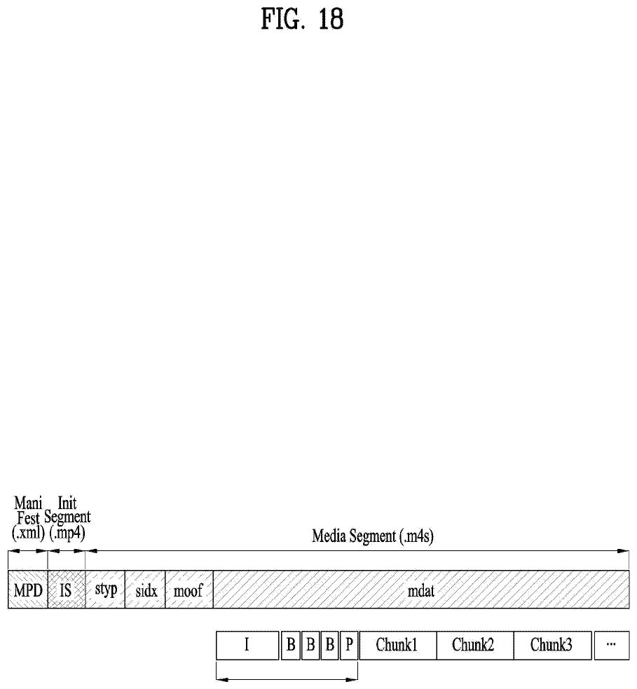

FIG. 18 is a diagram illustrating a structure of a DASH segment according to an embodiment of the present invention. The DASH segment is a data unit of a transfer object that may be reproduced for a predetermined duration by dividing the content to be transmitted into media segments. The DASH media segment includes a ‘styp’ box indicating the segment type and a ‘sidx’ box containing segment index information. In addition, the DASH media segment may include a ‘mdat’ box containing a media stream truncated in fragment units and a ‘moof’ box containing metadata thereabout. The DASH client may request transmission of an MPD file, which is a manifest file, to request a service, and may request a media segment through each segment Uniform Resource Locator (URL). To decode the media segment, the DASH client may receive an parse an initialization segment (IS) file containing initialization information, perform decoder initialization, and then receive the requested media segment file and perform media parsing and decoding.

Files received by the DASH client may be classified according to components for media playback. The DASH client may play the media after receiving the MPD, which is a manifest file, the initialization segment file, and the media segment file. Therefore, the media encoder of the transmitting terminal may encode mdat including media data for the entire play block (MPD+IS+sidx+moof+mdat) and generate a metadata header (styp+sidx+moof) including the encoding information. Thereafter, the transmitting terminal may generate an IS.mp4 file, which is decoder initialization information, write the MPD including the URL information about the segment and transmit the same to the DASH client. The parsing order of the receiving terminal is as follows. The receiving terminal may receive and parse the MPD file, initialize the decoder, and request a media segment according to network conditions.

In the case where the DASH segments stored in various qualities provide a live type service or a service of transmitting data by encoding live broadcast content, the real-time operation of the entire media service framework is applied. Therefore, delay should be minimized to realize a seamless service. When a delay occurs in encoding and packetizing real-time content and parsing and decoding the real-time content during live broadcasting using the DASH protocol, a delay may occur at the start of the service. In other words, when each media file is generated, packetized, and transmitted, a delay time corresponding to a reception time of the packet and time to wait until the entire packet is generated for parsing of the packet may be produced. As a result, the buffering time becomes longer on the client side. To address this issue, the following method is proposed.

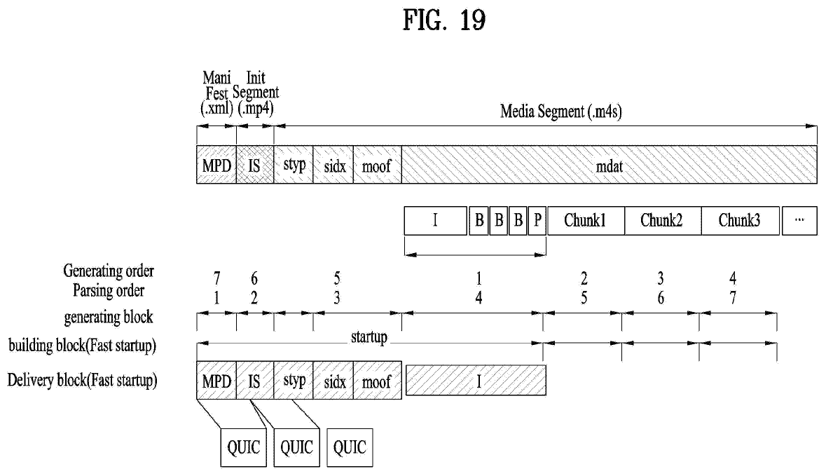

FIG. 19 is a diagram illustrating a structure of a DASH segment, a generating order, and a parsing order according to an embodiment of the present invention. MPD, IS, sidx, moof, and I frames described in the previous drawings may be configured as a single building block and pre-transmitted in order to reduce transmission/reception delay of media data and to allow the receiving terminal to quickly play media. This block may be referred to as a fast startup building block. Using the transmitted MPD, the DASH client may execute playback through MPD transmission and the segment request according to the conventional model in the unicast manner. While operating the DASH framework, the DASH client may execute fast startup using the I frame included in the single building block and received with the MPD. In other words, the server of the transmitting terminal may selectively transmit the I frame rather than transmitting the entire mdat frames covered by the moof header, thereby reducing the reception delay. In addition, the DASH client may perform a fast audio and video (AV) startup by starting playback from the I frame, which is a random access point (RAP). In addition, in case of live broadcasting, instead of generating all segments of the entire qualities, the transmitting terminal server may selectively generate a representation/segment that enables fast startup, in consideration of the network situation or according to the consideration of the network operator, and generating and transmit a light MPD therefore. The DASH client may receive the light MPD and configure the fast startup building block to quickly start playing. Thereafter, the DASH client may receive a segment of another quality through the proxy to perform bitstream switching according to the qualities of the segments. In summary, the transmitting terminal server may perform transmission considering only segments for fast startup, and may include segment information for fast startup in the MPD to minimize the delay in playing the media data.

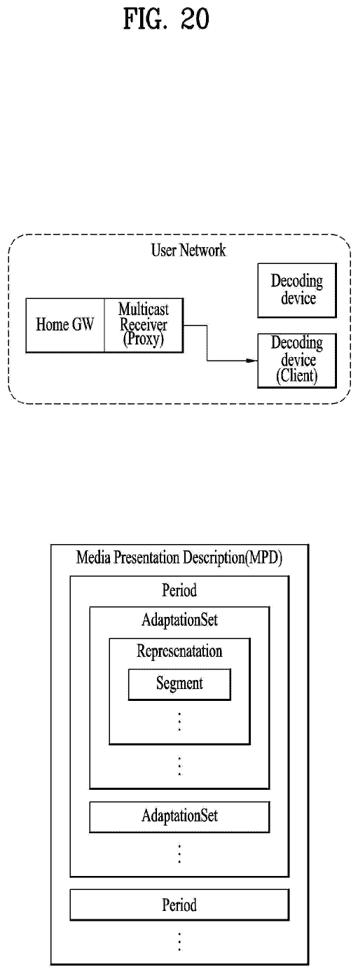

FIG. 20 is a diagram illustrating a user network and an MPD according to an embodiment of the present invention. As shown in the upper part of the figure, when the client requests the DASH content stored in the proxy to receive the service, the existing MPD does not have content indicating the fast startup segment mode (Fastmode) described in the previous figure. Therefore, when the client accesses the component, signaling indicating a segment for fast access, that is, a fast startup segment is needed. The lower part of the figure shows the hierarchical structure of the MPD. The MPD is configured in a hierarchical structure including elements and attributes. In each layer, elements and attributes that contain information about media content describe structural functions and roles. Description of the video and audio component levels starts with Adaptation-Set, which has one or more Representation entries. Representation includes information about URL paths of the segments, and the client may perform bitstream switching between the Representations according to network conditions.

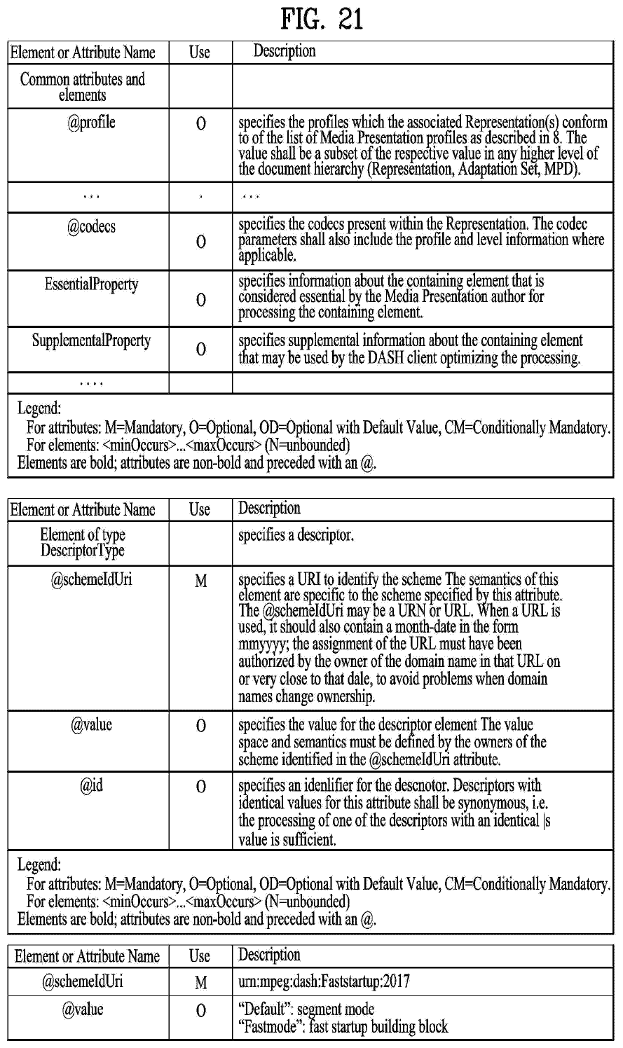

FIG. 21 is a diagram illustrating details of an MPD according to an embodiment of the present invention. The aforementioned Representation in the MPD may include a descriptor that may indicate a common attribute. The Representation may include a common attribute descriptor as shown in the upper part of the figure. The common attributes may include a Supplemental Property descriptor, through which an element necessary for the framework of the corresponding representation may be defined. Elements of such a descriptor type may define an attribute indicating what operation should be performed through the schemeIdUri attribute as shown in the middle of the figure, and may define a specific code point for a specific operation through value attributes. The information for fast startup described above may be defined in the MPD through extension of a new Supplemental Property descriptor, thereby signaling a representation capable of fast startup among the representation entries. That is, as shown at the bottom of the figure, the schemeIdUri attribute may be defined as fast startup, and the existing segment mode and the fast mode for the fast startup may be defined for the value attributes. The Fastmode may signal, to the DASH client, that fast startup using the fast startup building block described in the previous figure is allowed.

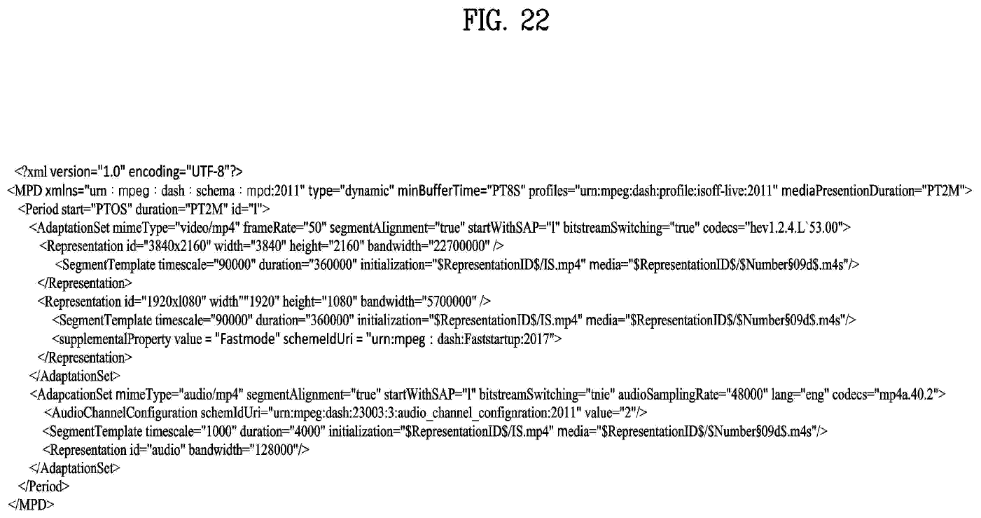

FIG. 22 illustrates an MPD for fast startup according to an embodiment of the present invention. As shown in the figure, the MPD may be expressed in XML, and may define the schemeIdUri attribute of the Supplemental Property element as Faststartup and set the value attribute to Fastmode for a Representation that supports fast startup. Thereby, the MPD may signal to the DASH client that the representation supports the aforementioned fast startup.

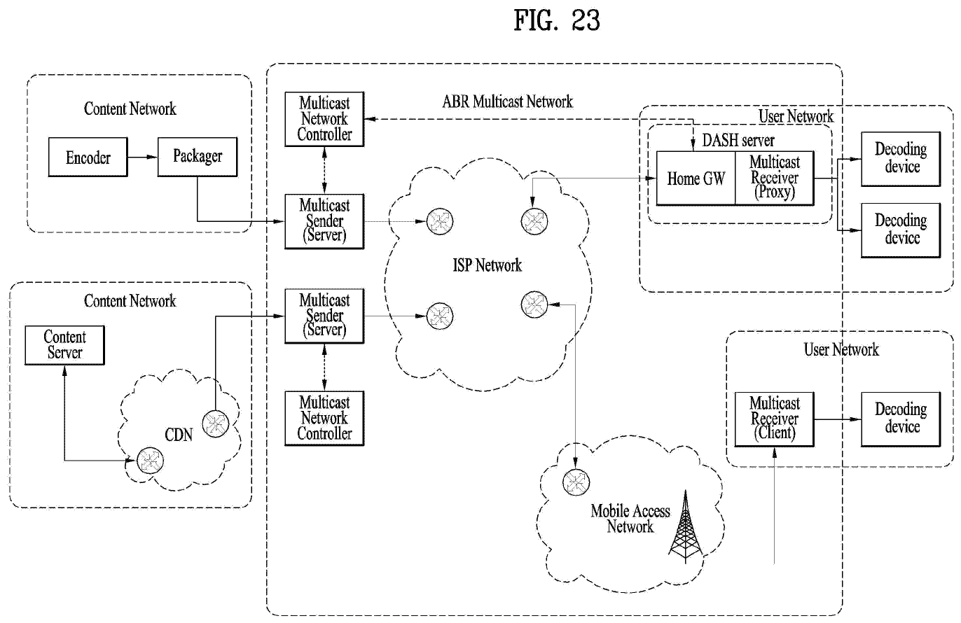

FIG. 23 is a diagram illustrating a network configuration for multicast according to an embodiment of the present invention. Unlike the above-described embodiments, the multicast may be implemented in this embodiment without receiving the MPD file from the server. This scheme may be referred to as an MPD less scheme. In DASH live streaming for a multicast service, the DASH server, which is the multicast sender, may generate content, assign URLs to respective segments, write and transmit an MPD, and start the streaming service. However, due to network instability and network conditions that do not guarantee a bit rate, a delay may occur between generating the DASH content for each quality and starting the DASH service. In contrast, for a communication network in a user network, the bit rate is guaranteed, and therefore the network conditions for a DASH service may be supported.

Therefore, the DASH server may be positioned in the user network. That is, the conventional multicast model may be maintained for networks leading up to the user network in order for the content network to transmit packets immediately after generating the packets. The DASH server in the user network may collect the received packets to generate URLs of the segments, generate an MPD according to the DASH hierarchy, and perform a streaming service with the DASH client in a unicast manner In other words, the existing DASH server may be moved to the user network, and the DASH server may collect segment files received from the multicast sender and update the MPD to perform the service.

For example, the content server preferentially generates HD segments and starts to transmit the same through the multicast sender, and the DASH server of the user network generates an MPD including information about a representation preferentially generated among the segment packets. In this case, the multicast network controller may transmit control packets through synchronization and management of MPD timeslots from a service perspective. The decoding device, which is a DASH client, may receive unicast HTTP streaming through the generated MPD according to the existing DASH model. This may enable the service to be quickly provided by changing the home gateway or multicast receiver alone without changing the existing DASH client.

Adaptive streaming, such as DASH and Http Live Streaming (HLS), may start only after generation of a content file containing content to be transmitted and metadata containing the attributes of the file. As mentioned in the previous figures, before all the media segment files to be transmitted are generated, a media segment file that can be preferentially transmitted may be transmitted using the existing multicast model. Once an ordering for playing a file at the proxy is generated, a manifest file (e.g., an MPD file) may be generated to play a media segment file transmitted first. That is, according to the existing multicast model, when multicast data or receivable unicast packets are cached in the multicast receiver or the proxy within the multicast ABR model, the multicast receiver or the proxy may create an MPD based on a specific time point. When a DASH segment stored with a plurality of qualities provides a linear service, segments corresponding to the plurality of qualities should be sequentially transmitted to the IP network. Thereby, a service delay may be caused. To overcome this issue, fast data reception may be performed and some media segments may be preferentially received and quickly played back. In the following description, priority of a packet transmission may be defined in consideration of the size of data and a reception time in a playback unit. The packet transmission according to the priority may speed up the rendering of the playback unit, thereby lowering the startup delay.

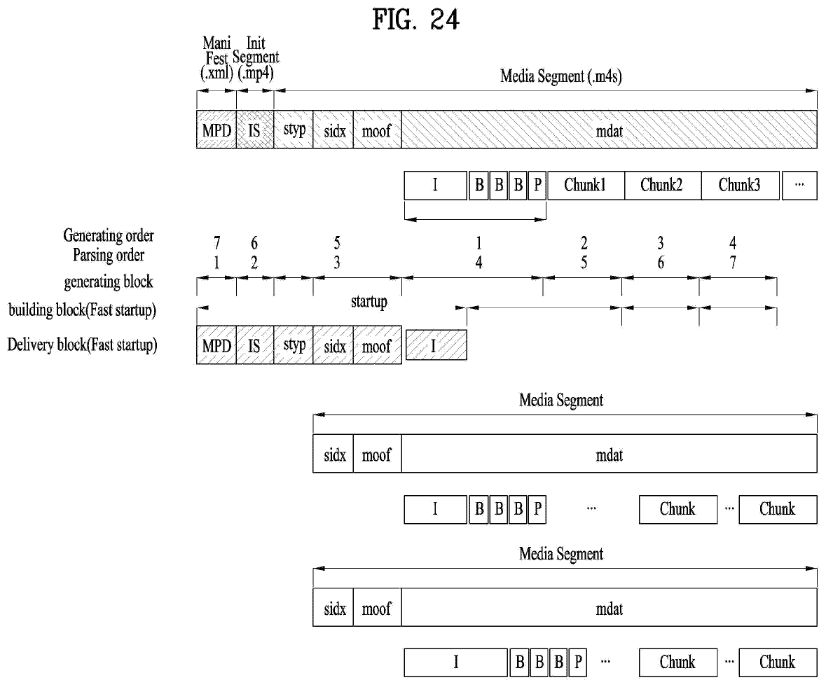

FIG. 24 is a diagram illustrating a process of generating a DASH segment according to an embodiment of the present invention. A segment to be transmitted may be generated according to the generating order shown in the figure and may be transmitted according to the delivery block. Since the media segment has a longer segment length as the quality increases, a delay may occur in generating and transmitting the entire segments. Therefore, it is necessary to separately generate and transmit a segment that can be subjected to fast startup among the segments. In addition, data generated according to the generated block should be partially packetized according to the delivery object and transmitted. To this end, the packet may carry an object including only the I frame capable of RAP, not the entire sequence. As shown in the figure, after 1, 2, 3, 4, 5, and 6 are generated according to the generating order, the delivery object may be configured to include only the I frame. Upon receiving the delivery object, the receiving terminal may perform decoding through the RAP. Thereafter, the transmitting terminal may continuously transmit an object including the remaining media chunk packets to enable playback of subsequent frames at the receiving terminal. The mode of transmitting a delivery object selectively including only the I frame described above is referred to as a fast startup mode. For this purpose, a multicast ABR may be implemented by extending the protocol. In the following description, an extension of Quick UDP Internet Connections (QUIC), which is a protocol that is applicable to a scalable IP-based TV distribution system, is proposed.

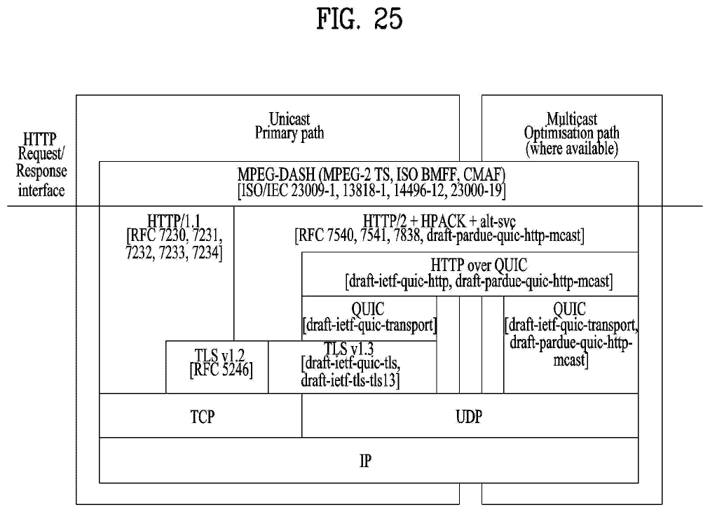

FIG. 25 is a diagram illustrating a QUIC protocol stack according to an embodiment of the present invention. QUIC is a UDP-based object delivery protocol for the scalable IP-based TV distribution system. QUIC may compensate for the shortcomings of connection long-standing between a TCP-based user and server, and enable transmission of UDP datagrams using FEC, similarly to TCP. In addition, QUIC may multiplex and transmit associated application level data and support multicast with an HTTP-based Web-oriented mechanism. That is, QUIC may support both multicast and unicast.

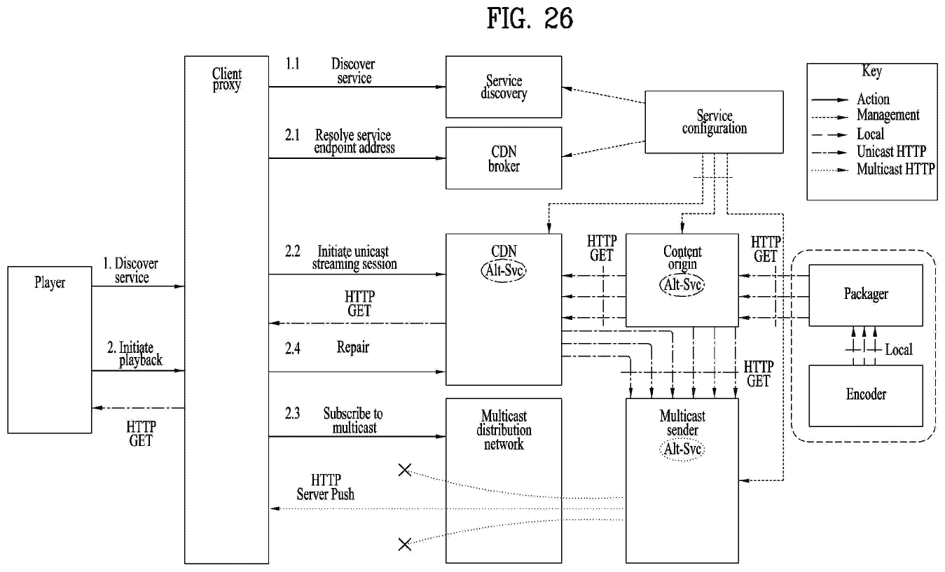

FIG. 26 is a diagram illustrating a multicast method to which the QUIC protocol is applied according to an embodiment of the present invention. The QUIC protocol, which supports UDP-HTTP based multicast/unicast, is a delivery protocol for transmitting media segments. HTTP Alternative Services (Alt-Svc) may support the function of providing services through a multicast server after a client connects in a unicast manner. The specific operations of the QUIC and Alt-Svc scenarios are described below. FIG. 26 illustrates a service for multicast ABR to which the QUIC protocol is applied. A Reverse proxy procedure of the service for multicast ABR is described below. This scenario represents a scenario where data is requested at a specific real time point by requesting a linear service based on the proxy.

As a first step, the client may complete the service handshake through discovery. As a second step, a client application or a linear service player may access a service session of the CDN in a unicast manner for playback of a timeslot corresponding to the current time. The client may make a request and a response through HTTP GET and acquire, from the response, information about an accessible multicast network address. The client may request a subscription through the multicast network address. As a third step, the client may receive a service by receiving a packet in the form of an HTTP server push.

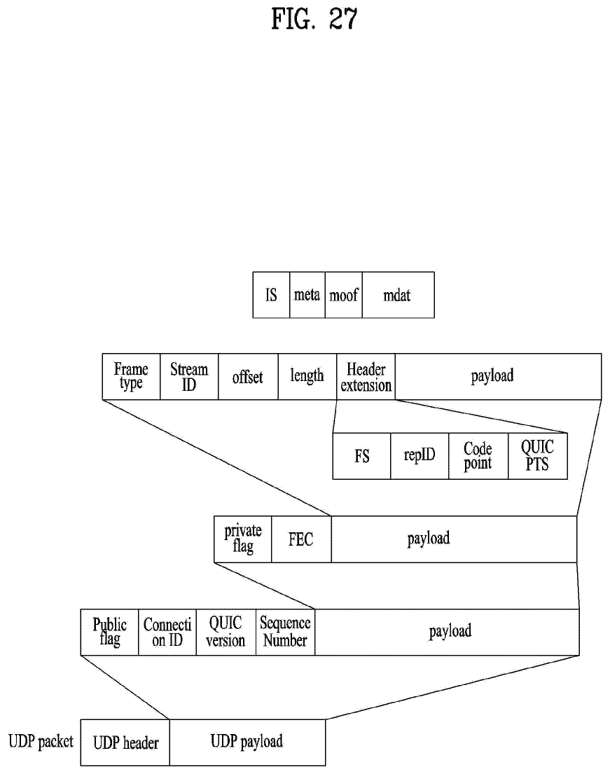

FIG. 27 is a diagram illustrating QUIC header extension according to an embodiment of the present invention. The UPD packet may be divided into a UDP header and a UDP payload. The UDP payload may include a QUIC packet header and a QUIC packet payload. The QUIC packet header may include a public flag field, a connection ID field, a QUIC version field, a sequence number field, a private flag field, an FEC field, a frame type field, a stream ID field, an offset field, and a length field. It may further include a header extension field. Here, the frame type field, stream ID field, offset field, and length field may be classified into a stream frame header. The public flag field may indicate whether the QUIC version field is included in a packet and whether the packet is a public reset packet. The public flag field may also indicate the size of the connection ID field and whether a packet sequence number is present in the packet. The connection ID field indicates an identifier of a connection selected by the client. The QUIC version field indicates the version of the QUIC protocol. This field may be present when public flags include FLAG_VERSION. The sequence number field may indicate lower bits of a sequence number when the public flags indicate presence of the sequence number. The private flag field may indicate whether a corresponding packet includes an entropy, an FEC byte is present, and whether the packet is an FEC packet. The FEC field may indicate the packet sequence number of the first packet in an FEC group. The frame type field may indicate the type of a frame and indicate whether the frame is a stream frame. The frame type field may also indicate whether a data length field is present, and indicate the length of an offset field or the length of a stream ID field. In addition, according to an embodiment of the present invention, an ABR segment expansion case may be indicated. The stream ID field may indicate an identifier of the corresponding stream. The offset field may indicate a byte offset in the stream for the corresponding data block. The length field may indicate the length of data in the stream frame.

When the content provider provides a QUIC protocol based linear service, the QUIC protocol may support fast AV startup by extending the QUIC header information. As shown in the figure, the frame type included in the QUIC header may indicate the ABR segment extension case using a new value. When a segment is transmitted with this value, values of the header extension included in the QUIC header may be extended. The header extension field included in the QUIC header may include an FS field, a repID field, a code point field, and a QUIC PTS field. According to an embodiment, the FS, repID, code point, and QUIC PTS fields may be included as separate fields in the QUIC header. The FS field represents a fast start value of a packet containing a DASH segment, and may indicate whether a packet of a linear service is a packet for fast startup. If the FS field is 0x0, this may indicate that the segment included in the packet is an MPD, an existing DASH model, or a complete segment. If the FS field is 0x1, this may indicate that the mode is a fast startup mode and the MPD is present. That is, the FS field 0x1 may indicate that the packet constitutes a fast startup block, and that the MPD is present and thus content can be configured through the timeline and representation information in the MPD. If the FS field is 0x2, this may indicate that the mode is fast startup mode, and that the MPD is not needed. In this case, the client may start decoding immediately according to the NTP reference and QUIC PTS value of UDP without following the MPD timeline. The value of 0x3 of the FS field may be utilized later. The repID field represents a representationID (aligned with DASH) of the corresponding stream, and may indicate a value including the quality or the bandwidth of the stream. The code point field may indicate whether the IS is included and whether the entire segment is fragmented. If the value of the code point field is 0, this may indicate Default. If the value is 1, this may indicate that a new initialization segment (IS) is included in the packet and that the entire segment is unfragmented. If the value of the code point field is 2, this may indicate that a new IS is included in the packet and that the entire segment is fragmented. If the value of the code point field is 3, this may indicate that a media segment is included in the packet and that the entire segment is unfragmented. If the value is 4, this may indicate that a media segment is included in the packet and that the entire segment is fragmented. The QUIC_PTS field may represent a time stamp for the start of a fast startup block received by MPD less transmission. This field may be available only in the MPD less case. Here, “MPD less” may refer to a scenario in which a receiver cannot acquire available start time because no separate MPD is transmitted as described with reference to FIG. 23. That is, when the MPD is not transmitted and the receiver cannot acquire the parsing time of the QUIC packet or the start time of broadcasting, the receiver may determine the parsing time or the start time of broadcasting using QUIC_PTS. As described above, the header of the QUIC protocol may be extended to support the fast startup.

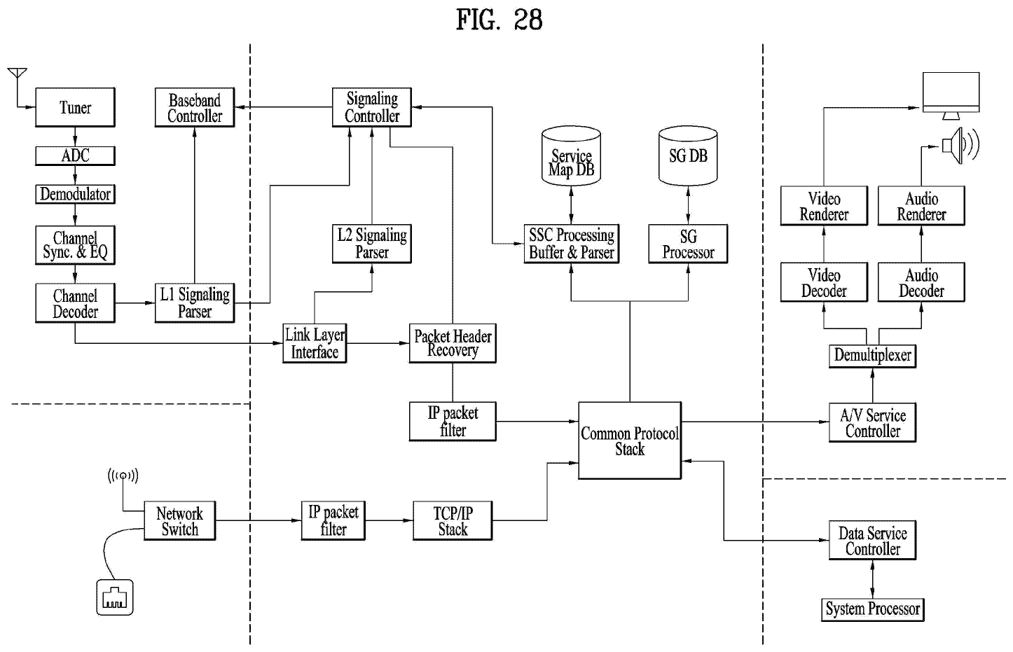

FIG. 28 is a diagram illustrating a receiver structure according to an embodiment of the present invention. The receiver may receive a broadcast signal or a multicast signal using a tuner. The receiver may convert an analog signal into a digital signal using an analog-digital converter (ADC) and demodulate the received signal using a demodulator. The receiver may perform synchronization and equalization on the received signal using channel sync. & EQ, and decode the received signal using a channel decoder. The decoded signal is parsed by a layer 1 (L1) signaling parser, and thus the receiver may acquire L1 signaling information. The L1 signaling information may be delivered to a baseband controller of the receiver and used to acquire physical layer data. In addition, the L1 signaling information may be input to the signaling controller of the receiver. In addition, the decoded signal may be input to a link layer interface and parsed by an L2 signaling parser, and the L2 signaling information may be input to the signaling controller. The signaling controller may communicate with a service signaling channel (ssc) processing buffer and a parser to update a service MAP database (DB). In addition, a service guide (SG) processor may update the service guide DB. The receiver may restore a packet header according to the signaling information input to the signaling controller and receive an IP packet using an IP packet filter. In addition, the network switch of the receiver may receive the IP packet through wired or wireless communication, using a TCP/IP stack. The received IP packet is input to the A/V service controller via the common protocol stack. The demultiplexer of the receiver may demultiplex audio data and video data. The receiver may output audio data using an audio decoder and an audio renderer, and output video data using a video decoder and a video renderer.

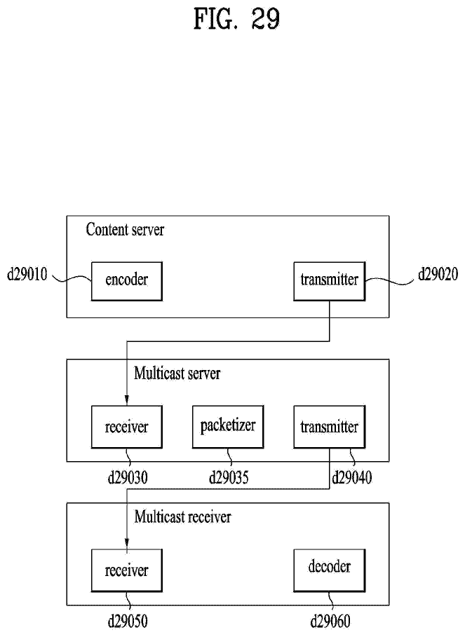

FIG. 29 is a diagram illustrating a content server, a multicast server and a multicast receiver according to an embodiment of the present invention. The content server may include an encoder d29010 and a transmitter d29020, and the multicast server may include a receiver d29030, a packetizer d29035, and a transmitter d29040. The multicast receiver may include a receiver d29050 and a decoder d29060. The content server may generate content using the encoder d29010, and may divide the generated content and store the same as media segments as described with reference to the previous figures. The content server may transmit the media segments to the multicast server using the transmitter d29020. In addition, the content server may generate an MPD. As described with reference to FIG. 21, information for fast startup may be defined in the MPD through extension of a new supplemental property descriptor. Thereby, a representation which can be subjected to fast startup among the representation entries may be signaled. That is, the schemeIdUri attribute may be defined as fast startup, and the existing segment mode and the fast mode for the fast startup may be defined for the value attributes to signal, to the DASH client, that fast startup using the fast startup building block is allowed.

The multicast server may receive media data from the content server and transmit the media data in the multicast manner. That is, the receiver d29030 in the multicast server may receive media data from the transmitter of the content server, and the transmitter d29040 in the multicast server may multicast the media data using the multicast protocol. The packetizer d29035 in the multicast server may packetize the media data into media data packets using QUIC. The media data packet may be a QUIC packet. As described with reference to FIG. 27, the QUIC header may be extended to signal fast startup-related information. That is, the ABR segment extension case may be indicated through the frame type included in the QUIC header. In this case, values the header extension included in the QUIC header may be extended. The header extension field included in the QUIC header may include an FS field, a repID field, a code point field, and a QUIC PTS field, and thus may provide signaling for fast startup and support fast startup.

The multicast receiver may receive media data from the multicast server using the receiver d29050. The receiver d29050 of the multicast receiver may receive the media data using QUIC, and may acquire fast startup-related information of the header extension field included in the QUIC header as described above. The multicast receiver may decode the media data using the decoder d29060. Then, the fast media startup may be performed using the fast startup-related information. In some embodiments, the decoder may be included in a separate decoding device. In this case, the multicast receiver may deliver, to the decoding device, the fast startup-related information along with the media data.

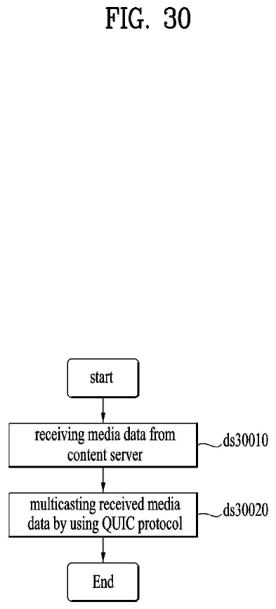

FIG. 30 illustrates a method of operating a multicast server according to an embodiment of the present invention. The multicast server may receive media data from the content server (ds30010). The multicast server may use the QUIC to multicast the received media data. As described with reference to FIG. 27, the multicast server may signal the fast startup-related information by extending the QUIC header included in the UDP packet. The multicast server may insert at least one of information about whether fast startup is supported, a representation ID of the media data, a code point, and QUIC presentation time stamp (PTS) information in the QUIC header. According to an embodiment, such information may be included in the header extension included in the QUIC header. The multicast server may multicast the media data using the QUIC (ds30020). The client may perform fast startup using the information included in the QUIC header or the header extension.

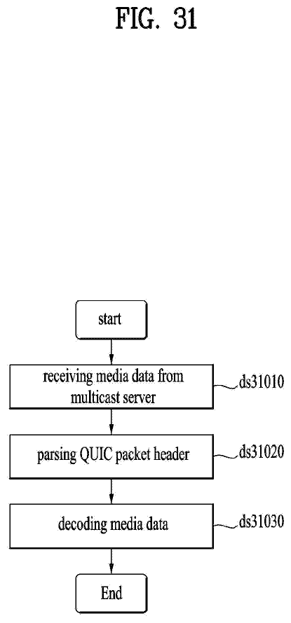

FIG. 31 illustrates a method of operating a multicast receiver according to an embodiment of the present invention. The multicast receiver may receive a multicast stream. According to an embodiment, the multicast receiver may include a decoding device. Hereinafter, a method of operating the multicast receiver including the decoding device will be described. The multicast receiver may receive media data from the multicast server (ds31010). The media data may be transmitted and received using the QUIC. The multicast receiver may acquire fast startup-related information by parsing the QUIC packet header. The fast startup-related information may be included in the QUIC packet header or the QUIC header extension included in the header. The multicast receiver may decode the media data based on the fast startup-related information and provide a multicast service to a user.

According to an embodiment of the present invention, multicast transmission between devices belonging to a conventional broadcast network, the Internet, a home network, and the like may be effectively provided.

According to an embodiment of the present invention, the load on the network may be reduced by switching the conventional unicast transmission to multicast transmission.

According to an embodiment of the present invention, the issue of delay caused by network conditions during a linear service and real-time live encoding may be overcome, and fast AV startup may be supported.

Although the description of the present invention is explained with reference to each of the accompanying drawings for clarity, it is possible to design new embodiments by merging the embodiments shown in the accompanying drawings with each other. If a recording medium readable by a computer, in which programs for executing the embodiments mentioned in the foregoing description are recorded, is designed by those skilled in the art, it may fall within the scope of the appended claims and their equivalents.

The devices and methods according to the present invention may be non-limited by the configurations and methods of the embodiments mentioned in the foregoing description. The embodiments mentioned in the foregoing description may be configured in a manner of being selectively combined with one another entirely or in part to enable various modifications.

In addition, the image processing method according to the present invention may be implemented with processor-readable code in a processor-readable recording medium provided to a network device. The processor-readable medium may include all kinds of recording devices capable of storing data readable by a processor. The processor-readable medium may include one of ROM, RAM, CD-ROM, magnetic tapes, floppy disks, optical data storage devices, and the like and also include carrier-wave type implementation such as a transmission via Internet. Furthermore, as the processor-readable recording medium is distributed to a computer system connected via a network, processor-readable code may be saved and executed in a distributed manner.

Although the invention has been described with reference to the exemplary embodiments, those skilled in the art will appreciate that various modifications and variations can be made in the present invention without departing from the spirit or scope of the invention described in the appended claims. Such modifications are not to be understood individually from the technical idea or viewpoint of the present invention

Both apparatus and method inventions are described in this specification and descriptions of both the apparatus and method inventions are complementarily applicable, if necessary.

### MODE FOR INVENTION

Various embodiments have been described in the best mode for carrying out the invention.

### INDUSTRIAL APPLICABILITY

The present invention is usable and repeatable in the field of broadcast and video signal processing.

1. A multicast transmission method comprising:
receiving media data;
packetizing the received media data into media data packets using a delivery protocol; and
multicasting the media data packets,
wherein each of the media data packets generated by the delivery protocol comprises a packet header and a payload,
wherein the packet header comprises information about fast startup.

2. The method of claim 1, wherein the fast startup supports fast presentation of the media data using a single building block, the single building block comprising a Media Presentation Description (MPD), an initialization segment file, and an ISO base media file format (ISOBMFF) file.

3. The method of claim 2, wherein the ISOBMFF file comprises a segment type box (styp), a segment index box (sidx), a movie fragment box (moof), and a media data box (mdat),
wherein the mdat box selectively comprises only an I frame of the media data.

4. The method of claim 1, wherein the delivery protocol is Quick UDP Internet Connections (QUIC),
wherein the packet header comprises at least one of information about whether the fast startup is supported, a representation ID of the media data, a code point, and QUIC presentation time stamp (PTS) information.

5. The method of claim 2, wherein the MPD comprises a descriptor indicating whether a representation belonging to the media data supports the fast startup.

6. A multicast transmission apparatus comprising:
a receiver configured to receive media data;
a packetizer configured to packetize the received media data into media data packets using a delivery protocol; and
a transmitter configured to multicast the media data packets,
wherein each of the media data packets generated by the delivery protocol comprises a packet header and a payload,
wherein the packet header comprises information about fast startup.

7. The multicast transmission apparatus of claim 6, wherein the fast startup supports fast presentation of the media data using a single building block, the single building block comprising a Media Presentation Description (MPD), an initialization segment file, and an ISO base media file format (ISOBMFF) file.

8. The multicast transmission apparatus of claim 7, wherein the ISOBMFF file comprises a segment type box (styp), a segment index box (sidx), a movie fragment box (moof), and a media data box (mdat),
wherein the mdat box selectively comprises only an I frame of the media data.

9. The multicast transmission apparatus of claim 6, wherein the delivery protocol is Quick UDP Internet Connections (QUIC),
wherein the packet header comprises at least one of information about whether the fast startup is supported, a representation ID of the media data, a code point, and QUIC presentation time stamp (PTS) information.

10. The multicast transmission apparatus of claim 7, wherein the MPD comprises a descriptor indicating whether a representation belonging to the media data supports the fast startup.

11. A multicast reception method comprising:
receiving media data packets according to a delivery protocol, wherein each of the media data packets generated by the delivery protocol comprises a packet header and a payload, and the packet header comprises information about fast startup; and
a decoder for acquiring information about the fast startup and performing the fast startup by decoding the received media data packets,
wherein the fast startup supports fast presentation of the media data using a single building block, the single building block comprising a Media Presentation Description (MPD), an initialization segment file, and an ISO base media file format (ISOBMFF) file,
wherein the ISOBMFF file comprises a segment type box (styp), a segment index box (sidx), a movie fragment box (moof), and a media data box (mdat),
wherein the mdat box selectively comprises only an I frame of the media data.

12. The method of claim 11, wherein the delivery protocol is Quick UDP Internet Connections (QUIC),
wherein the packet header comprises at least one of information about whether the fast startup is supported, a representation ID of the media data, a code point, and QUIC presentation time stamp (PTS) information.

13. The method of claim 11, wherein the MPD comprises a descriptor indicating whether a representation belonging to the media data supports the fast startup.

14. A multicast reception apparatus comprising:
a receiver configured to receive media data packets according to a delivery protocol, wherein each of the media data packets generated by the delivery protocol comprises a packet header and a payload, and the packet header comprises information about fast startup; and
a decoder configured to acquire information about the fast startup and perform the fast startup by decoding the received media data packets,
wherein the fast startup supports fast presentation of the media data using a single building block, the single building block comprising a Media Presentation Description (MPD), an initialization segment file, and an ISO base media file format (ISOBMFF) file,
wherein the ISOBMFF file comprises a segment type box (styp), a segment index box (sidx), a movie fragment box (moof), and a media data box (mdat),
wherein the mdat box selectively comprises only an I frame of the media data.

15. The method of claim 14, wherein the delivery protocol is Quick UDP Internet Connections (QUIC),
wherein the packet header comprises at least one of information about whether the fast startup is supported, a representation ID of the media data, a code point, and QUIC presentation time stamp (PTS) information,
wherein the MPD comprises a descriptor indicating whether a representation belonging to the media data supports the fast startup.
